(19) United States
(12) Patent Application Publication
(10) Pub. No.: US 2024/0290991 A1
(43) Pub. Date: Aug. 29, 2024

(54) Electrode and Electrochemical Storage Cell

(71) Applicant: Bayerische Motoren Werke Aktiengesellschaft, Muenchen (DE)

(72) Inventors: Roland JUNG, Muenchen (DE); Thomas WOEHRLE, Muenchen (DE); Nina ZENSEN, Pfaffenhofen an der Ilm (DE)

(21) Appl. No.: 18/570,948

(22) PCT Filed: May 19, 2022
(86) PCT No.: PCT/EP2022/063564

§ 371 Date: Dec. 15, 2023

(30) Foreign Application Priority Data
Jun. 18, 2021 (DE) 10 2021 115 799.4

(51) Int. Cl. H01M 4/80; H01M 50/531; H01M 50/627

(52) U.S. Cl. CPC H01M 4/80; H01M 50/531; H01M 50/627

(57) ABSTRACT

An electrode for an electrochemical storage cell is provided. The electrode includes a conductor foil having an application area and a contacting area, wherein an electrode coating is applied in the application area, and wherein the conductor foil is at least partially porous in the contacting region and not porous in the application are. Also, an electrochemical storage cell is specified.

### BACKGROUND AND SUMMARY

The invention relates to an electrode and to an electrochemical storage cell having such an electrode.

An electrochemical storage cell is an electrochemical-based energy storage means which is in particular rechargeable and is designed to store electrical energy and to provide it to consumers, for example consumers in a vehicle.

The electrochemical storage cell is especially a lithium ion battery, and so the invention relates more particularly to an electrode for a lithium ion battery and to a lithium ion battery having such an electrode.

The term “lithium ion battery” hereinafter is used synonymously for all terms for lithium-containing galvanic elements and cells that are commonly used in the art, for example lithium battery, lithium cell, lithium ion cell, lithium-polymer cell, lithium ion battery cell and lithium ion accumulator. In particular, rechargeable batteries (secondary batteries) are included. The terms “battery” and “electrochemical cell” are also used synonymously with the terms “lithium ion battery” and “lithium ion cell”. The lithium ion battery may also be a solid-state battery, for example a ceramic or polymer-based solid-state battery.

An electrochemical storage cell, especially a lithium ion battery, has at least two different electrodes: a positive electrode (cathode) and a negative electrode (anode). Each of these electrodes has at least one active material, electively together with additions such as electrode binders and electrical conductivity additives that have been applied to an electrically conductive carrier of the respective electrodes. Electrically conductive carriers used are in particular nonporous, solid-state output conductor foils composed of bulk material: aluminum (for the positive electrode) or copper (for the negative electrode), which are also known by the name “solid foils” in the technical jargon. Such output conductor foils are impervious to gases and liquid electrolyte.

Crucial factors for the performance of an electrochemical storage cell are the achievable energy density, the lifetime and the available charge and discharge rate, which is of particular importance especially in vehicle applications and should be at a maximum. However, the available charge and discharge rate is limited by various effects, including by the expected evolution of temperature during the charging and discharging operation, and by aging effects.

For use in the electrochemical storage cell, the electrodes are especially in the form of an electrode stack or winding, with a separator for electrical insulation disposed between every cathode and anode.

In the process for production of the electrochemical storage cell, it is necessary to impregnate the electrode stack or winding with electrolyte after introduction into a housing, with a need for a certain contact time in order to assure sufficient and uniform wetting of the internal porosity of the electrodes as far as the interface.

It is an object of the invention to specify a means of minimizing production complexity and manufacturing costs for an electrochemical storage cell. In addition, an electrochemical storage cell with high-performance and lifetime is to be enabled.

The object of the invention is achieved by an electrode for an electrochemical storage cell with an output conductor foil comprising an application region and a contact-connection region, wherein an electrode coating has been applied in the application region, and wherein the output conductor foil is at least partly porous in the contact-connection region and is nonporous in the application region.

According to the invention, no electrode coating has been applied in the contact-connection region. The contact-connection region serves for electrical contact connection of the electrode with external contacts or power leads of an electrochemical storage cell including the electrode of the invention.

The term “porous” is understood to mean the presence of at least one opening that extends across the entire thickness of the output conductor foil.

It has been recognized that the combination of a nonporous application region and a porous contact-connection region of the output conductor foil can give a particularly advantageous electrode for the process for production of electrochemical storage cells, for example lithium ion batteries. Because the application region is nonporous, the electrode coating can be applied to the output conductor foil without any great restrictions or plant modifications by means of known process procedures and equipment. In particular, the mechanical stability of the output conductor foil is not significantly impaired since the output conductor foil, in spite of the porous contact-connection region, behaves essentially like a conventional solid foil. At the same time, however, the porous contact-connection region, in the production of an electrochemical storage cell, enables rapid wettability of the electrode(s) and further components such as separators with electrolyte, since this can penetrate through the openings in the contact-connection region into an ensemble consisting of electrodes and separators. In addition, the total weight of the output conductor foil is reduced compared to an output conductor foil having a nonporous contact-connection region, which can increase the specific energy of an electrochemical storage cell comprising such an electrode.

The type of openings responsible for the porosity of the contact-connection region is not subject to any narrower restriction. For example, the openings have a circular, elliptical, rhombus-shaped or other polygonal outline.

The openings may be arranged in any desired geometry relative to one another.

In one variant, the openings to establish the porosity of the contact-connection region are obtainable by punching of the output conductor foil. Punching is a particularly inexpensive variant for creation of the necessary porosity. The punched-out constituents of the output conductor foil may be recycled for alternative uses, especially recycled as a single substance, or melted and processed further, for example to give new output conductor foil. The punching waste itself may also be employed for other purposes, for example as a cap for toothpaste tubes.

In a further variant, the openings to establish the porosity of the contact-connection region are obtained by laser cutting. In this method, by means of a continuous or pulsed laser beam, by controlled material ablation, material is removed from the output conductor foil and cut in this way. By means of laser cutting, it is especially possible to create openings that do not have any protruding burrs at their lateral edges.

In yet a further variant, the contact-connection region may be executed in the form of an expanded metal.

Preferably, in the production of the electrode of the invention, the porosity of the contact-connection region is created at a separate place and time from the applying of the electrode coating. In this way, it is possible to prevent metal glitter and/or other dusts formed while creating the openings in the contact-connection region from being deposited in or on the electrode coating or between separator and electrode. In this way, it is possible to significantly minimize the risk of soft shorts in electrochemical storage cells comprising electrodes of the invention.

However, it is also possible first to apply the electrode coating and then to create the openings in the contact-connection region. Especially when the openings are created by punching, it is possible to limit the formation of metal dusts with acceptable complexity, for example by means of a suction system. Such a process sequence offers the advantage that it is possible to use existing production plants for electrochemical storage cells, and for the output conductor foil to be particularly mechanically stable during the application of the electrode coating.

The contact-connection region is in particular an integral part of the output conductor foil. In other words, the contact-connection region is not merely mounted on the application region, for example by welding. In this way, no additional operating steps for securing of the contact-connection region have to be conducted, and the contact-connection region is stably connected to the remaining constituents of the electrode, which increases the lifetime of the electrode.

In order to enable a compact design, the contact-connection region may extend laterally along the application region of the output conductor foil. In particular, the contact-connection region directly adjoins the application region of the electrode.

In a preferred variant, the contact-connection region extends laterally over the entire length of the application region. In this variant, it is particularly effectively possible to minimize the transport distance of electrons within the output conductor foil and hence electrical resistance within the electrode. In this way, it is possible to achieve improved outward transport of heat in the operation of the electrode in an electrochemical storage cell, which in turn increases the reliability and lifetime of the electrode, and it is possible to use a higher charge and discharge rate in the operation of such an electrochemical storage cell.

In particular, the contact-connection region may form a continuous contact-connection strip along the application region of the output conductor foil.

In a further preferred variant, the contact-connection region comprises two or more mutually spaced conductor lugs. In other words, there is no continuous contact-connection strip in this variant. Such a configuration of the output conductor foil can be created by cutting, notching, i.e. lasering, or punching selected regions out of a continuous contact-connection strip. In other words, the contact-connection band is contoured, meaning that a contouring cut is performed. In this way, the weight of the electrode can be further reduced, and hence the specific energy of an electrochemical storage cell comprising the electrode can be increased further. However, the production complexity of the electrode is increased in this variant; in particular, a thorough suction of metal dusts has to be ensured in order to be able to reliably rule out later soft shorts of the electrode.

The conductor lugs may be spaced apart uniformly or at irregular distances.

It is also possible for the conductor lugs to have the same or a different width.

The object of the invention is also achieved by an electrochemical storage cell having an electrode arrangement disposed in a housing, wherein the electrode arrangement comprises an anode, a cathode, and a separator disposed between the anode and the cathode, and wherein the anode and/or the cathode is an electrode of the type described above.

The electrode arrangement may comprise two or more anodes and/or cathodes, in which case a separator is disposed between each directly mutually adjoining anode and cathode. In this case, at least one anode and/or at least one cathode is an electrode of the type described above.

In order to enable a compact design, the electrode arrangement may be a cylindrical electrode winding, a flat electrode winding or an electrode stack.

In a preferred variant, the electrode arrangement has two terminal end faces and the contact-connection region of the anode or of the cathode projects from one of the end faces of the electrode arrangement, wherein the housing is closed by a contact plate that makes electrical contact with the projecting contact-connection region of the anode or of the cathode. Such cell designs are known from WO 2020/096973 A1 and EP 3 258 519 A1.

The projecting contact-connection region of the anode or of the cathode is the porous contact-connection region of the electrode of the invention, i.e. a region without applied electrode coating. In other words, it is envisaged in accordance with the invention that the contact plate makes electrical contact with the porous contact-connection region.

The contact plate is welded to the housing, for example.

The contact plate especially has at least one access opening for filling of the housing with electrolyte, preferably two or more passage openings.

During the process for production of the electrochemical storage cell, the electrochemical storage cell has to be filled with electrolyte in the inner volume of the housing, such that the electrodes of the electrode arrangement and the separator can be substantially completely and uniformly wetted with electrolyte. By virtue of the contact plate having a passage opening, the contact plate itself can additionally be utilized to undertake the filling with electrolyte. Because the contact plate is contact-connected to the porous contact-connection region, the electrolyte fed in through the contact plate can penetrate essentially unhindered and hence rapidly into the electrode arrangement and the separator. In this way, the necessary contact time before complete wetting of the electrode arrangement with electrolyte is minimized, while it is simultaneously possible to assure uniform and reliable wetting of all electrodes of the electrode arrangement and of the separator.

The passage opening(s) of the contact plate may additionally be utilized for degassing of the electrochemical storage cell. Even in the process for production of the electrochemical storage cell, a corresponding degassing process has to be conducted in what is called the pre-charge or formation, especially during and/or after the first charging and discharging operation.

The projecting contact-connection region of the anode or of the cathode may be at least partly folded over in the direction of the end face. In this variant, an even more compact design of the electrochemical storage cell is possible, while the porosity of the at least partly folded-over contact-connection region still ensures reliable wetting with electrolyte, reliable degassing of the electrochemical storage cell and reliable contact connection.

In a further variant, both the anode and the cathode are an electrode of the invention as described above. If the electrode arrangement has more than one anode and/or one cathode, in this variant, all anodes and cathodes in particular are an electrode of the invention of the type described above.

The electrochemical storage cell is especially a lithium ion cell.

Further advantages and properties will be apparent from the description of preferred embodiments that follows, which should not be understood in a restrictive sense, and from the drawings. The drawings show:

### BRIEF DESCRIPTION OF THE DRAWINGS

FIG. 1: a first embodiment of an electrode of the invention,

FIG. 2: an electrode arrangement comprising the electrode according to FIG. 1,

FIG. 3: an alternative electrode arrangement comprising the electrode according to FIG. 1,

FIG. 4: a schematic section view through the electrode arrangement from FIG. 2,

FIG. 5: a first embodiment of an electrochemical storage cell of the invention with the electrode arrangement from FIG. 4 with the contact plate in place,

FIG. 6: a schematic top view of a first embodiment of the contact plate from FIG. 5,

FIG. 7: a schematic top view of a second embodiment of the contact plate from FIG. 5,

FIG. 8: a partial view of the electrochemical storage cell according to FIG. 5 during filling with electrolyte,

FIG. 9: a partial view of the electrochemical storage cell according to FIG. 5 during a degassing process,

FIG. 10: a second embodiment of the electrode of the invention,

FIG. 11: a schematic section view through an electrode arrangement comprising the electrode according to FIG. 10,

FIG. 12: a second embodiment of an inventive electrochemical storage cell with the electrode arrangement from FIG. 11,

FIG. 13: a partial view of the electrochemical storage cell according to FIG. 12 during filling with electrolyte, and

FIG. 14: a partial view of the electrochemical storage cell according to FIG. 12 during a degassing process.

### DETAILED DESCRIPTION OF THE DRAWINGS

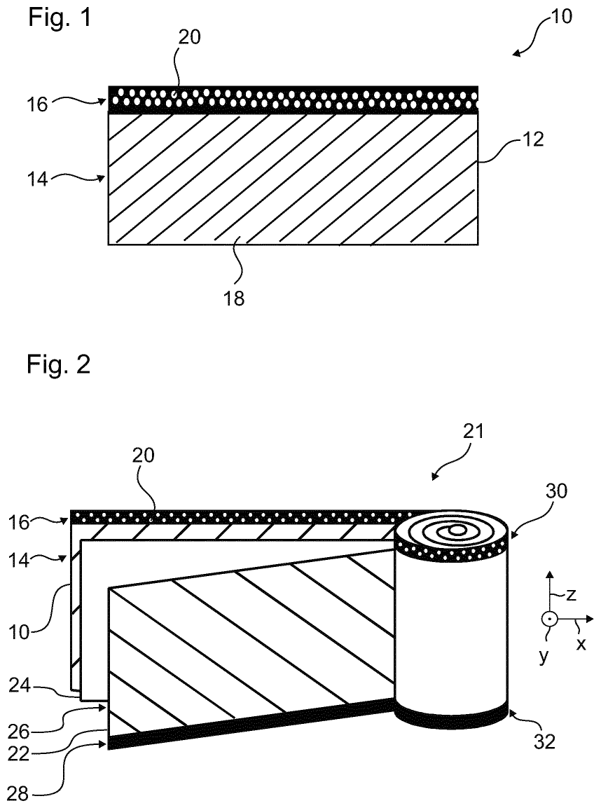

FIG. 1 shows an inventive electrode 10 in a top view.

The electrode 10 comprises an output conductor foil 12 having an application region 14 and a contact-connection region 16.

The output conductor foil 12 is especially an aluminum or copper foil.

In the application region 14, an electrode coating 18 has been applied to the output conductor foil 12.

The electrode coating 18 comprises an electrochemical active material, an electrode binder, and optionally additives, for example an electrical conductivity additive. The type of electrochemical active material, of electrode binder and of the optional additives is not subject to any further restriction, and so it is possible to use any of the electrode coatings 18 known in the art that are suitable for an intended use of the electrode 10.

The contact-connection region 16 has a multitude of openings 20 that extend through the entire thickness of the output conductor foil 12. In other words, the contact-connection region 16 is porous.

By contrast with the contact-connection region 16, the application region 14 of the output conductor foil 12 is nonporous; in FIG. 1, the nonporous structure of the output conductor foil 12 in the application region 14 cannot be seen because of the electrode coating 18 already applied. Because of the nonporous structure of the application region 14, the electrode coating 18 can be applied to the application region 14 by any of the conventional methods known in the art without any need for significant adjustments in the production process.

In the embodiment shown, the openings 20 have an elliptical outline. In principle, however, the opening 20 may have any geometry, for example a circular, rhombus-shaped or polygonal outline.

The openings 20 shown in FIG. 1 are obtainable by punching material out of the output conductor foil 12 in the contact-connection region 16. It is fundamentally also possible to use different methods of creating the openings 20, for example laser cutting.

The contact-connection region 16 runs laterally over the entire length of the application region 14 and directly adjoining the application region 14. In this way, the transport distance of electrons that have to be transported through the electrode 10 in operation thereof is shortened. This lowers the resulting electrical resistance of the electrode 10, such that excessive heating of the electrode 10 and the formation of local hotspots in operation of the electrode 10 can be reliably avoided.

The contact-connection region 16 is configured in the form of a continuous contact-connection strip. Therefore, no additional processing steps are needed for contouring of the contact-connection region 16 in the application region 14, which can lower the level of complexity in the production of the electrode 10.

Moreover, the contact-connection region 16 is an integral part of the output conductor foil 12, meaning that the contact-connection region 16 has not been mounted subsequently on the application region 14.

In principle, however, it is also possible to mount the contact region 16 on the application region 14, for example by means of welding on the application region 14 before or after the applying of the electrode coating 18.

FIG. 2 shows a schematic of a partly rolled-up electrode arrangement 21.

The partly rolled-up electrode arrangement 21 comprises the above-described electrode 10, a counterelectrode 22, and a separator 24 disposed between the electrode 10 and the counterelectrode 22 that electrically insulates the electrode 10 and the counterelectrode 22 from one another.

In the embodiment shown in FIG. 2, the electrode 10 is an anode and the counterelectrode 22 a cathode. In principle, however, it would also be possible for the electrode 10 to be a cathode and the counterelectrode 22 an anode. It would likewise be possible for the electrode arrangement 21 to comprise a multitude of anodes and cathodes that are each electrically insulated from one another by a separator 24.

The counterelectrode 22, analogously to the electrode 10, comprises a counterelectrode coating region 26 and a counterelectrode contact-connection region 28, where the counterelectrode contact-connection region 28, by contrast with the contact-connection region 16 of the electrode 10, is nonporous.

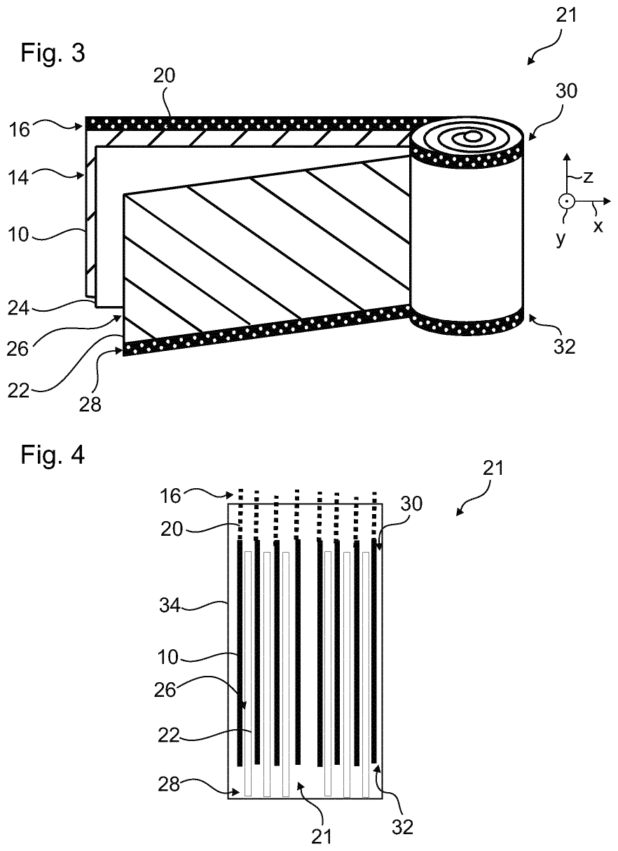

Alternatively, it would be possible for the counterelectrode 22 likewise to be an inventive electrode 10 as described above, as shown by the alternative embodiment in FIG. 3. In this case, the counterelectrode contact-connection region 28 is likewise porous and corresponds essentially to the contact-connection region 16 of the electrode 10.

The electrode arrangement 21, in the embodiments shown, is a cylindrical electrode winding and has a first terminal end face 30 and a second terminal end face 32.

The contact-connection region 16 of the electrode 10, i.e. the anode, projects from the first terminal end face 30, while the counterelectrode contact-connection region 28, i.e. the cathode, projects from the other second terminal end face 32.

FIG. 4 shows a schematic section view of a fully rolled-up electrode arrangement 21 according to FIG. 2 after it has been accommodated in a housing 34, without explicitly showing the separator 24 to simplify the drawing. The housing 36 is made, for example, from aluminum or stainless steel.

As can be seen in FIG. 4, the rolling-up of the electrode arrangement 21 to give a cylindrical electrode winding results in a compact arrangement in which there is a resultant sequence, viewed in cross section, of electrode 10 and counterelectrode 22, i.e. of anode and cathode.

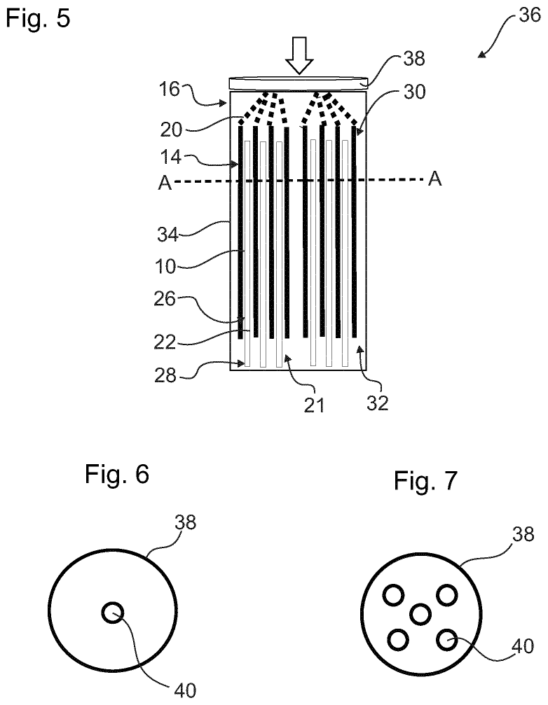

FIG. 5 shows an inventive electrochemical storage cell 36 in which the housing 34 is closed by placing a contact plate 38 on top, as indicated by an arrow. The contact plate 38 can then be secured on the housing 34, for example by welding.

The contact plate 38 serves for electrical contact connection of the contact-connection region 16, where the individual ends of the contact-connection region 16 may be combined for contact connection, for example by folding together as shown in FIG. 5 or by means of a clip (not shown). By comparison with a contact-connection region which is nonporous, the openings 20 make it possible for the assembled contact-connection region 16 to be less thick and to have less of a tendency to form creases.

The contact plate 38 has at least one access opening 40, as shown in top view in FIG. 6. The at least one access opening 40 serves to fill the housing 34 with electrolyte and to degas the housing 34, i.e. to remove gases formed within the housing 34.

The contact plate 38 may have a multitude of access openings 40, as shown in the alternative embodiment in FIG. 7.

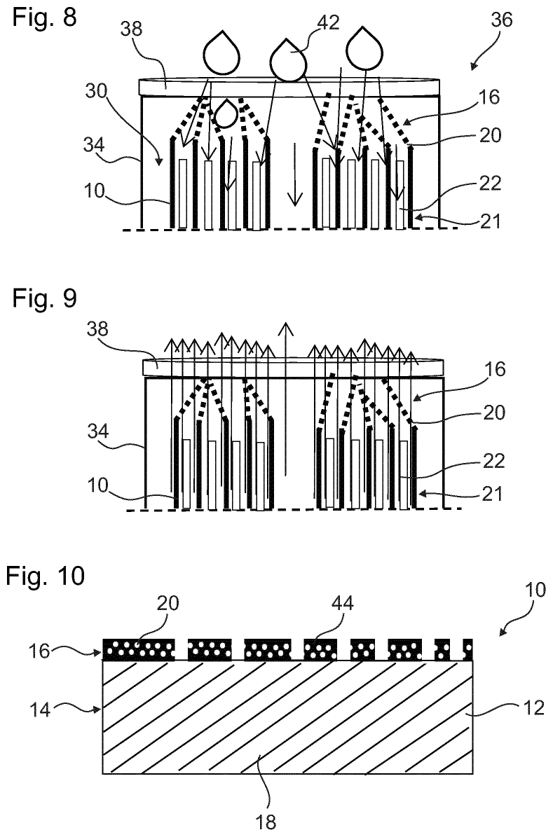

FIG. 8 shows a partial view of the electrochemical storage cell 36 while the housing 34 is being filled with electrolyte 42. As can be seen, the porous structure of the contact-connection region 16 makes it possible for the electrolyte 42 to penetrate through the contact-connection region 16 and to fill up the housing 34 via a multitude of flow pathways, as indicated by the arrows in FIG. 8.

In this way, the use of the inventive electrode 10 enables rapid, uniform and complete wetting of the entire electrode arrangement 21. Thus, there is both an acceleration of the process for production of the electrochemical storage cell 36 and an increase in the performance and lifetime of the electrochemical storage cell 36.

It additionally becomes clear from FIG. 8 that the access openings 40 of the contact plate 38 may fundamentally be arranged in any desired manner since penetration and wetting by the electrolyte is still possible through the porous contact-connection region 16 across the entire interior of the housing 34.

FIG. 9 shows a partial view of the electrochemical storage cell 36 during a degassing operation, for example for removal of gases that have formed during the first charging and discharging operation of the electrochemical storage cell 36. As indicated by arrows in FIG. 9, the gases, because of the porous structure of the contact-connection region 16, can be removed from the electrode arrangement 21 via a multitude of flow pathways and subsequently from the housing 34 via the at least one access opening 40 of the contact plate 38. It is thus possible to reliably prevent buildup of a positive pressure within the housing 34 and hence to increase the reliability and lifetime of the electrochemical storage cell 36. In particular, it is not possible for a local positive pressure to build up between adjacent electrodes since gases formed can in any case be removed via the porous contact-connection region 16.

FIG. 10 shows a second embodiment of the inventive electrode 10. The second embodiment corresponds essentially to the first embodiment, and so only the differences will be addressed hereinafter. Reference is made to the remarks above.

In the second embodiment, the contact-connection region 16 is not in the form of a continuous contact-connection strip but in the form of a multitude of conductor lugs 44. These are obtainable, for example, by removing part-regions or part-sections of an initially existing contact-connection strip. The reduction in the amount of material in the contact-connection region 16 can further reduce the weight of the electrode 10 and hence further increase the specific energy of an electrochemical storage cell 36 having such an electrode 10.

The individual conductor lugs 44 may have the same width along the application region 14 or, as shown in FIG. 10, different widths. It is likewise possible for the conductor lugs 44 to be spaced apart at the same distance from one another, as shown in FIG. 10, or to be spaced apart from one another to different degrees.

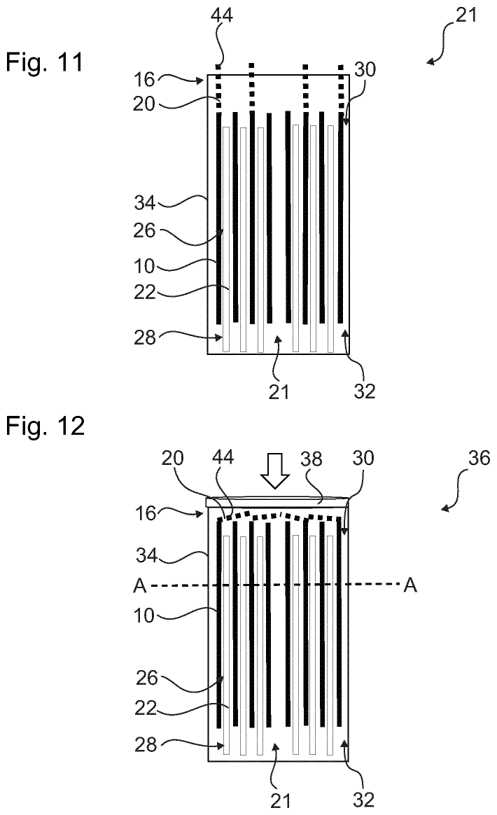

FIG. 11 shows a fully rolled-up electrode arrangement 21 comprising the electrode 10 according to FIG. 10. By comparison with the representation from FIG. 4, it becomes clear that the partial removal of material from the contact-connection region 16 results in a lower space requirement.

FIG. 12 shows a second embodiment of the electrochemical storage cell 36. The second embodiment corresponds essentially to the first embodiment, and so only differences are discussed hereinafter. Reference is made to the above remarks.

In the second embodiment of the electrochemical storage cell 36, the conductor lugs 44 of the contact-connection region 16 are folded over onto the first end face 30 of the electrode arrangement 21, which results in a more compact design of the electrochemical storage cell 36.

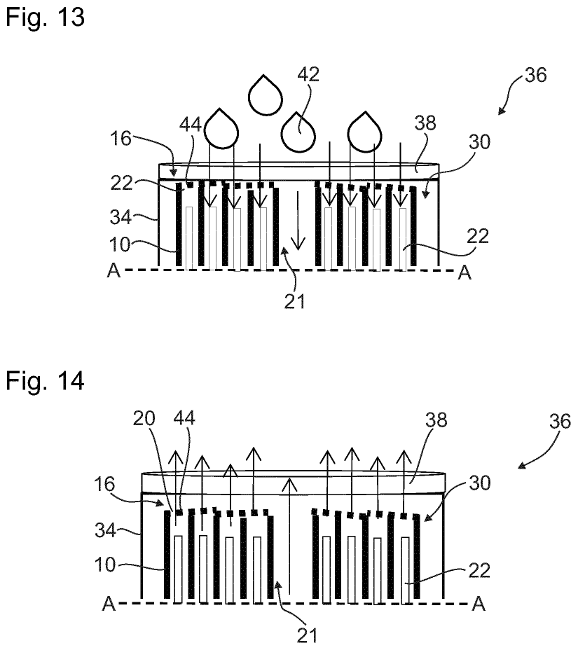

By virtue of the porous contact-connection region 16, or by virtue of the porous conductor lugs 44, the electrode arrangement 21, even in the case of folded-over conductor lugs 44, can be wetted rapidly, uniformly and completely with electrolyte, as indicated by arrows in FIG. 13, which is configured analogously to FIG. 8. Moreover, reliable degassing is still possible, as indicated by arrows in FIG. 14, which is configured analogously to FIG. 9.

The inventive electrode 10 enables simple and rapid production of the inventive electrochemical storage cell 36, which features high reliability and performance and a long lifetime.

1.-10. (canceled)

11. An electrode for an electrochemical storage cell, the electrode comprising:
an output conductor foil including an application region and a contact-connection region;
wherein an electrode coating has been applied in the application region, and wherein the output conductor foil is at least partly porous in the contact-connection region and is nonporous in the application region.

12. The electrode according to claim 11, wherein the contact-connection region is an integral part of the output conductor foil.

13. The electrode according to claim 11, wherein the contact-connection region extends laterally along the application region of the output conductor foil.

14. The electrode according to claim 12, wherein the contact-connection region extends laterally along the application region of the output conductor foil.

15. The electrode according to claim 11, wherein the contact-connection region comprises multiple mutually spaced conductor lugs.

16. The electrode according to claim 12, wherein the contact-connection region comprises multiple mutually spaced conductor lugs.

17. The electrode according to claim 13, wherein the contact-connection region comprises multiple mutually spaced conductor lugs.

18. The electrode according to claim 14, wherein the contact-connection region comprises multiple mutually spaced conductor lugs.

19. An electrochemical storage cell having an electrode arrangement disposed in a housing, wherein the electrode arrangement comprises an anode, a cathode, and a separator disposed between the anode and the cathode, wherein the anode and/or the cathode is an electrode including an output conductor foil including an application region and a contact-connection region, wherein an electrode coating has been applied in the application region, and wherein the output conductor foil is at least partly porous in the contact-connection region and is nonporous in the application region.

20. The electrochemical storage cell according to claim 19, wherein the electrode arrangement is a cylindrical electrode winding, a flat electrode winding or an electrode stack.

21. The electrochemical storage cell according to claim 19, wherein the electrode arrangement has two terminal end faces and the contact-connection region of the anode or of the cathode projects from one of the end faces of the electrode arrangement, and wherein the housing is closed by a contact plate that makes electrical contact with the projecting contact-connection region of the anode or of the cathode.

22. The electrochemical storage cell according to claim 20, wherein the electrode arrangement has two terminal end faces and the contact-connection region of the anode or of the cathode projects from one of the end faces of the electrode arrangement, and wherein the housing is closed by a contact plate that makes electrical contact with the projecting contact-connection region of the anode or of the cathode.

23. The electrochemical storage cell according to claim 21, wherein the projecting contact-connection region of the anode or cathode is at least partly folded over in the direction of the end face.

24. The electrochemical storage cell according to claim 22, wherein the projecting contact-connection region of the anode or cathode is at least partly folded over in the direction of the end face.

25. The electrochemical storage cell according to claim 21, wherein the contact plate has at least one access opening for filling of the housing with electrolyte, preferably two or more access openings.

26. The electrochemical storage cell according to claim 23, wherein the contact plate has at least one access opening for filling of the housing with electrolyte, preferably two or more access openings.

27. The electrochemical storage cell according claim 19, wherein the anode and the cathode are the electrode including the output conductor foil including the application region and the contact-connection region, wherein the electrode coating has been applied in the application region, and wherein the output conductor foil is at least partly porous in the contact-connection region and is nonporous in the application region.
